(19) United States
(12) Patent Application Publication
(10) Pub. No.: US 2026/0243211 A1
(43) Pub. Date: Aug. 20, 2026

(54) METHOD FOR OPERATING AN INTERNAL COMBUSTION ENGINE, COMPUTER PROGRAM, CONTROL DEVICE FOR AN INTERNAL COMBUSTION ENGINE, COMBUSTION ENGINE AND METHOD FOR DESIGNING AN INTERNAL COMBUSTION ENGINE

(71) Applicant: Rolls-Royce Solutions GmbH, Friedrichshafen (DE)

(72) Inventor: Daniel Bergmann, Bad Wurzach (DE)

(73) Assignee: Rolls-Royce Solutions GmbH, Friedrichshafen (DE)

(21) Appl. No.: 19/542,104

(22) Filed: Feb. 17, 2026

(30) Foreign Application Priority Data
Feb. 17, 2025 (DE) 10 2025 105 926.8

(51) Int. Cl. F02D 41/14

(52) U.S. Cl. CPC F02D 41/1401; F02D 2041/1433

(57) ABSTRACT

A method for operating an internal combustion engine includes the steps of: feeding at least one input variable to an internal combustion engine model; using a Gaussian process as the internal combustion engine model; using, as an output variable vector, a vector that is an element of a vector space with D>1 dimensions; using a covariance function, which is configured to be represented as a product of a component-by-component calculated basis covariance function over a plurality of components of the output variable vector, wherein the basis covariance function cannot be decomposed into a product of functions of exactly one dimension of the vector space over the dimensions of the vector space; calculating the output variable vector using the internal combustion engine model; and operating the internal combustion engine with the output variable vector.

### CROSS REFERENCE TO RELATED APPLICATIONS

The present application claims priority to German patent application no. 10 2025 105 926.8, filed Feb. 17, 2025, which is incorporated herein by reference.

### BACKGROUND OF THE INVENTION

### 1. Field of the Invention

The present invention relates to internal combustion engines.

### 2. Description of the Related Art

When operating an internal combustion engine based on an internal combustion engine model created from test bench or training data, the problem of correct extrapolation and interpolation regularly arises. In particular, when a Gaussian process is used as the internal combustion engine model, values predicted by the internal combustion engine model outside the training data or between data points in the training data may be grossly incorrect if monotonic properties of the behavior of the internal combustion engine operated with the internal combustion engine model are not correctly considered by the internal combustion engine model. Such a fundamental monotonic property is, for example, that an increase in the amount of fuel introduced into a combustion chamber of the internal combustion engine can only lead to an increase in the torque of the internal combustion engine, but not to a reduction in it. However, if, for example, the functions underlying the engine model sag between individual data points of the training data—which means that the functions between any two immediately adjacent data points take on values smaller than either of the two data points—the model can locally misrepresent the actual behavior of the internal combustion engine. This applies in particular to peripheral regions of a state space spanned by the model. In order to correctly reproduce such monotonic properties when creating a model of an internal combustion engine and in the operation of the combustion engine, it is necessary to create a fine grid of constraints spanning the entire state space at gradients of the functions of the combustion engine model, whereby the fine grid is close-meshed in the sense that it has more grid points in all dimensions of the state space than the combustion engine model itself has support points in the respective dimension. This involves a considerable computational effort, which cannot be accomplished with standard PCs.

### SUMMARY OF THE INVENTION

The invention relates to a method for operating an internal combustion engine, a computer program, and a control device for an internal combustion engine to carry out such a method, to an internal combustion engine and to a method for designing an internal combustion engine.

The present invention in a first aspect in particular provides a method—also referred to as first operating method—for operating an internal combustion engine, wherein at least one input variable is fed to an internal combustion engine model, wherein
a Gaussian process is used as the combustion engine model, wherein
as an output variable vector, a vector is used that is an element of a vector space with D>1 dimensions, wherein
a covariance function is used, which can be represented as the product of a component-by-component calculated basis covariance function over components of the output variable vector, wherein
the basis covariance function cannot be decomposed into a product of functions of exactly one dimension of the vector space over the dimensions of the vector space, wherein
the output variable vector is calculated using the internal combustion engine model, and wherein
the internal combustion engine is operated with the output variable vector.

Advantageously, the condition that the basis covariance function cannot be decomposed into a product of functions of exactly one dimension of the vector space over the dimensions of the vector space allows for the selection of a basis covariance function that can be easily and quickly computed, that is, with low computational power. Furthermore, since the covariance function can be represented as the product of the component-by-component calculated basis covariance function over the components of the output variable vector, all that is required for correct mapping of the monotonic properties is a coarser grid of constraints on the gradients of the functions of the internal combustion engine model with a clearly reduced number of grid points, which only need to be arranged, in particular, along imaginary connecting lines in the individual dimensions at the support points of the internal combustion engine model and optionally between the support points, but not additionally between these imaginary connecting lines. This is because of the specific choice of the covariance function, a projection onto each individual dimension is possible. Thus, the data and computing effort for correct reproduction of the monotonic properties is drastically reduced, and the internal combustion engine model can be calculated and/or created with the computing power of a conventional standard PC available at the time of determining the priority of the present intellectual property right.

In the context of the present technical teaching, a method for operating the internal combustion engine is understood in particular to be a method for controlling or regulating the internal combustion engine.

The variable D∈ [symbol] specifies the number of dimensions of the vector space. The vector space is in particular a state space of the combustion engine.

In one design, a covariance function is used, which can be represented as the product of a component-by-component calculated basis covariance function over all components of the output variable vector.

In one design, a basis covariance function is used that cannot be decomposed into a product of functions of exactly one dimension of the vector space over all dimensions of the vector space. This means, in particular, that the basis covariance function is not a Gaussian function.

Thus, the covariance function is not a product of Gaussian functions and is not a Gaussian function itself. Although a Gaussian function would always meet the condition of being representable as the product of a component-by-component calculated basis covariance function over the components of the output variable vector, the computing power required for the method would be very high. Since the present method relies on a basis covariance function, which itself cannot be decomposed into a product of functions of exactly one dimension of the vector space over the dimensions of the vector space, and in particular is not a Gaussian function, the method can be performed with significantly lower computing power and is therefore more efficient and cost-effective.

The fact that the internal combustion engine is operated with the output variable vector means, in particular, that the internal combustion engine is controlled with the output variable vector.

A further development of the present invention provides that the basis covariance function will be a truncated power function. Advantageously, the calculations can be carried out particularly efficiently on the basis of such a basis covariance function.

A further development of the present invention provides that the truncated power function depends on a distance—in particular, a Euclidean distance—between the respective component of the output variable vector and an assigned component of a predetermined vector space grid vector.

A further development of the present invention provides that, as the basis covariance function, function

$${k}_{j} ( x , {X}_{j} ) = {\prod }_{i = 1}^{D} {k}^{′} ( {x}_{i} , {X}_{j , i} ) = {\prod }_{i = 1}^{D} max ( 0 , {( 1 - \frac{{‖ {x}_{i} - {X}_{j , i} ‖}_{2}^{2}}{2 {l}_{N}^{2} p} )}^{p} ) , \qquad ( 2 )$$

with the output variable vector x, the vector space grid vector Xj, a length scale parameter l_{N}, and a parameter p, in particular an exponent p, is used. In the following, bold lowercase letters without indices denote vectors, bold uppercase letters without indices denote matrices; thus, X is a matrix, x and Xj are vectors, xi and Xj,i are scalars, and in particular, xi is the components of vector x in dimension i, while Xj,i is the matrix component of matrix X in dimensions j and i.

In one embodiment, p=8.

Component kj(x,Xj) of vector-valued covariance function k(x,X) is then given by:

$${k}_{j} ( x , {X}_{j} ) = {\prod }_{i = 1}^{D} {k}^{′} ( {x}_{i} , {X}_{j , i} ) = {\prod }_{i = 1}^{D} max ( 0 , {( 1 - \frac{{‖ {x}_{i} - {X}_{j , i} ‖}_{2}^{2}}{2 {l}_{N}^{2} p} )}^{p} ) , \qquad ( 2 )$$

that is, as a product of the basis covariance function k′(xᵢ,X_{j,i}) over all dimensions.

A further development of the present invention provides that the method will be carried out continuously during the operation of the internal combustion engine. This ensures that the advantages resulting from the method are achieved throughout the operation of the internal combustion engine.

One embodiment provides that the internal combustion engine model includes a Gaussian process model. The Gaussian process optionally includes a Gaussian process model for each input variable.

Gaussian process models are especially suitable for controlling or regulating an internal combustion engine: Compared to polynomial-based models, they are notably easier to adapt to new or changed data points in the field of application, and they exhibit a more suitable and physically more correct behavior in peripheral regions of the given state space. Compared to physical models, you need considerably less computational effort. They also enable the direct use of test bench data.

Such a Gaussian process model is defined in particular by a regular grid of support points X_{N} in the D-dimensional vector space [symbol] , where grid n∈ [symbol] has support points, spaced uniformly per dimension, so that X_{N}∈ [symbol] is a support point matrix of n^{D} output variable vectors X_{Nj} each with D components. Each component—or in other words, each dimension—corresponds to an output variable, and the n^{D} output variable vectors can be assigned to different operating states of the internal combustion engine. The support points are optionally arranged in the vector space in such a way that the latter is completely covered by the support points, that is, in particular, that support points are arranged also in the peripheral regions of the vector space.

Each support point is assigned support point input variables y_{N}, which serve as free parameters of the Gaussian process model. Thus, the support point matrix X_{N} has assigned to it a support point input vector y_{N}, whereby each output variable vector X_{Nj} has assigned to it a scalar support point input variable y_{Nj}.

In principle, the Gaussian process model should enable the calculation of random input variables y(x) depending on random output variable vectors x∈ [symbol] in the vector space—or, vice versa when operating the internal combustion engine, as explained in more detail below—provide a function ƒ: [symbol] , optionally according to equation

$$y ( x ) = k ( x , {X}_{N} ) {K}^{- 1} {y}_{N} \qquad ( 3 )$$

with the vector-valued covariance function k(x, X_{N})∈ [symbol] according to equation (2), the covariance matrix K=k(X_{N}, X_{N})∈ [symbol] , and support point input vector y_{N}∈ [symbol] .

The Gaussian process model is finally obtained by optimizing it with a measurement data set (X_{b},y_{b}) obtained in test bench tests, where X_{b}εRo^{xD}D are output variables for o different operating states and y_{b}εRo is a vector with an input variable for each of the o operating states. In particular, output variables X_{b} represent a set of control values for the internal combustion engine. Input variables y_{b} are a set of resulting variables of the internal combustion engine depending on the drive values.

The Gaussian process model is created, trained, or optimized to calculate the input variables based on the output variables. From the perspective of the model itself, the output variables represent inputs to the model, and conversely, the input variables represent outputs of the model. However, when operating the internal combustion engine, the Gaussian process model trained or optimized in this way is used in reverse—it virtually calculates backwards—to determine, when an input variable is specified, those output variables with which the input variable can be realized, so that the internal combustion engine can then be controlled with these output variables. The output variables are, for example, control values for flaps in a gas path or a fuel quantity to be injected; the input variables can be, for example, a desired torque, a specific boost pressure, fuel consumption, emission values to be complied with, or the like, in other words, generally variables to be achieved or complied with by suitable adjustment of the output variables.

In particular, the Gaussian process model is optimized by optimizing the support point input variables y_{N} as free parameters of the Gaussian process model depending on the measurement data set (X_{b},y_{b}) in order to find optimized support point input variables y*_{N}:

$${y}_{N}^{*} = {arg min}_{{y}_{N}} {\sum }_{i = 1}^{o} ( {y}_{b , i} - k ( {X}_{bi} , {X}_{N} ) {K}^{- 1} {y}_{N} ) . \qquad ( 4 )$$

With the optimized support point input variables y*_{N}, random input variables y(x) can then be calculated depending on random output variable vectors x∈ [symbol] in vector space [symbol] according to:

$$y ( x ) = k ( x , {X}_{N} ) {K}^{- 1} {y}_{N}^{*} . \qquad ( 5 )$$

With abbreviation

$$a := {K}^{- 1} {y}_{N}^{*} ∈ {ℝ}^{{n}^{D}} \qquad ( 6 )$$

and the covariance function according to equation (2) the following results:

$$y ( x ) = {\sum }_{j = 1}^{{n}^{D}} ( {\prod }_{i = 1}^{D} max ( 0 , {( 1 - \frac{{‖ {x}_{i} - {X}_{Nj , i} ‖}_{2}^{2}}{2 {l}_{N}^{2} p} )}^{p} ) {α}_{j} ) . \qquad ( 7 )$$

Extracting the term for the first dimension i=1 from the product term, results in:

$$y ( x ) = {\sum }_{j = 1}^{{n}^{D}} ( {\prod }_{i = 2}^{D} max ( 0 , {( 1 - \frac{{‖ {x}_{i} - {X}_{Nj , i} ‖}_{2}^{2}}{2 {l}_{N}^{2} p} )}^{p} ) max ( 0 , {( 1 - \frac{{‖ {x}_{1} - {X}_{Nj , 1} ‖}_{2}^{2}}{2 {l}_{N}^{2} p} )}^{p} ) {α}_{j} ) ; \qquad ( 8 )$$

and with j:=nm+l:

$$y ( x ) = {\sum }_{m = 0}^{{n}^{D - 1} - 1} {\sum }_{l = 1}^{n} ( {\prod }_{i = 2}^{D} max ( 0 , {( 1 - \frac{{‖ {x}_{i} - {X}_{N n m + l , i} ‖}_{2}^{2}}{2 {l}_{N}^{2} p} )}^{p} ) max ( 0 , {( 1 - \frac{{‖ {x}_{1} - {X}_{N nm + l , 1} ‖}_{2}^{2}}{2 {l}_{N}^{2} p} )}^{p} ) {α}_{n m + l} ) \qquad ( 9 )$$

Now, one skillfully makes use of the fact that, due to the construction of the regular grid in the equally regular support point matrix X_{N}, blocks with length n result in support point matrix X_{N} from the second dimension onwards, each of which has identical entries for all l, so that the corresponding product terms can be factored out as constants cₘ.

$${c}_{m} := {\prod }_{i = 2}^{D} max ( 0 , {( 1 - \frac{{‖ {x}_{i} - {X}_{N n m + l , i} ‖}_{2}^{2}}{2 {l}_{N}^{2} p} )}^{p} ) , \qquad ( 10 )$$

providing the following result:

$$y ( x ) = {\sum }_{m = 0}^{{n}^{D - 1} - 1} ( {c}_{m} {\sum }_{l = 1}^{n} ( max ( 0 , {( 1 - \frac{{‖ {x}_{1} - {X}_{N nm + l , 1} ‖}_{2}^{2}}{2 {l}_{N}^{2} p} )}^{p} ) {α}_{n m + l} ) ) . \qquad ( 11 )$$

For example, the block-by-block constant support point matrix X_{N} for a grid normalized to an interval [0,1] in each dimension with 3 equidistant support points per dimension in a two-dimensional vector space is:

$${X}_{N} = ( \begin{matrix}0 & 0 \\ 0.5 & 0 \\ 1 & 0 \\ 0 & 0.5 \\ 0.5 & 0.5 \\ 1 & 0.5 \\ 0 & 1 \\ 0.5 & 1 \\ 1 & 1\end{matrix} ) = ( \begin{matrix}{X}_{N 1 , 1} & {X}_{N 1 , 2} \\ {X}_{N 2 , 1} & {X}_{N 2 , 2} \\ {X}_{N 3 , 1} & {X}_{N 3 , 2} \\ {X}_{N 4 , 1} & {X}_{N 4 , 2} \\ {X}_{N 5 , 1} & {X}_{N 5 , 2} \\ {X}_{N 6 , 1} & {X}_{N 6 , 2} \\ {X}_{N 7 , 1} & {X}_{N 7 , 2} \\ {X}_{N 8 , 1} & {X}_{N 8 , 2} \\ {X}_{N 9 , 1} & {X}_{N 9 , 2}\end{matrix} ) . \qquad ( 12 )$$

Accordingly, vector x has the following shape:

$$x = ( \begin{matrix}{x}_{1} \\ {x}_{2}\end{matrix} ) . \qquad ( 13 )$$

In a second aspect, the present invention in particular provides a method for operating an internal combustion engine, also known as a second operating method, wherein
the internal combustion engine is operated with an internal combustion engine model, wherein
the internal combustion engine model is created as a Gaussian process in that
   as an output variable vector of the Gaussian process, a vector is used that is an element of a vector space with D>1 dimensions, wherein
   in the Gaussian process, a covariance function is used, which can be represented as the product of a component-by-component calculated basis covariance function over—in particular, all—components of the output variable vector, wherein
   the basis covariance function cannot be decomposed into a product of functions of exactly one dimension of the vector space over the—in particular, all—dimensions of the vector space, wherein
   the Gaussian process is optimized on the basis of a measurement data set, wherein
   the internal combustion engine model is obtained.

In connection with the second operating procedure, advantages arise in particular that have already been explained in connection with the first operating method.

A further development of the present invention provides that constraints for gradients in the dimensions of the vector space are considered when optimizing the Gaussian process based on the measurement data set. Since the covariance function can be represented as a product of the component-by-component calculated basis covariance function over the components of the output variable vector, only a comparatively coarse grid with grid points is required for the constraints on the gradients, which only have to be arranged at the support points and optionally along imaginary connecting lines in the individual dimensions between the support points of the internal combustion engine model, but not also between these connecting lines.

In a third aspect, the present invention, in particular, provides a computer program which offers commands which, when the computer program is executed on a computing device, especially a control device for an internal combustion engine, cause the computing device to perform a first or second operating method according to the present invention, or a first or second operating method according to one or more of the embodiments described above. In connection with the computer program, advantages arise that have already been explained in connection with the first or second operating method.

The present invention in a fourth aspect in particular provides a computer-readable storage medium on which a computer program according to the present invention or a computer program according to one or more of the embodiments described above is stored. In connection with the computer-readable storage medium, advantages arise in particular that have already been explained in connection with the first operating method, the second operating method or the computer program.

The present invention in a fifth aspect in particular provides a control device for an internal combustion engine, wherein the control device is designed to carry out a first or second operating method according to the present invention or a first or second operating method according to one or more of the embodiments described above. In connection with the control device, advantages arise in particular that have already been explained in connection with the first operating method, the second operating method, the computer program, or the computer-readable storage medium.

The present invention in a sixth aspect in particular provides an internal combustion engine with a control device according to the present invention or a control device according to one or more of the embodiments described above. In connection with the combustion engine, advantages arise in particular that have already been explained in connection with the first operating method, the second operating method, the computer program, the computer-readable storage medium or the control device.

In a seventh aspect, the present invention provides in particular that a method—also referred to as a design method—is created for the design of an internal combustion engine, wherein
an internal combustion engine model is created as a Gaussian process in that
as an output variable vector of the Gaussian process, a vector is used that is an element of a vector space with D>1 dimensions, wherein
in the Gaussian process, a covariance function is used, which can be represented as the product of a component-by-component calculated basis covariance function over—in particular, all—components of the output variable vector, wherein
the basis covariance function cannot be decomposed into a product of functions of exactly one dimension of the vector space over the—in particular, all—dimensions of the vector space, wherein
the Gaussian process is optimized on the basis of a measurement data set, wherein
the combustion engine model is obtained, and
the internal combustion engine is designed to be operated with the internal combustion engine model.

In connection with the design method, advantages arise which have already been explained in connection with the first operating method, the second operating method, the computer program, the computer-readable storage medium, the control device or the internal combustion engine. Advantageously, the internal combustion engine model can be created very efficiently and with low computing power, especially on a standard PC.

A further development of the present invention provides that constraints for gradients in the dimensions of the vector space are considered when optimizing the Gaussian process based on the measurement data set. It is advantageous to use a comparatively coarse grid to consider the constraints on the gradients, which only has grid points that are arranged in the support points themselves and optionally along imaginary connecting lines in the individual dimensions between the support points of the internal combustion engine model, but not additionally between these connecting lines. This makes the design method very efficient and allows it to be performed on a standard PC.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a design method according to the state of the art;

FIG. 2 is a first schematic representation of an example of a design method; and

FIG. 3 is a second schematic representation of the design method according to FIG. 2.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

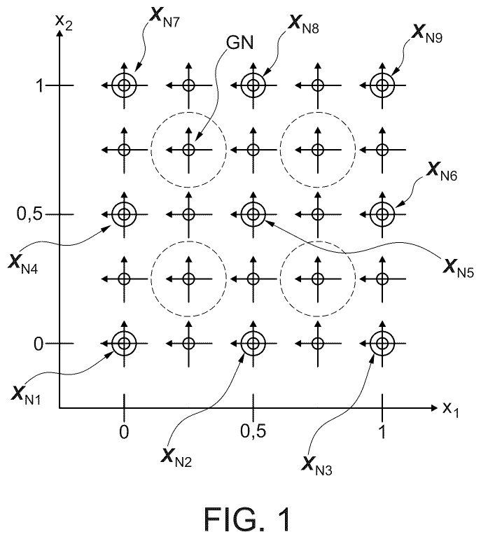

FIG. 1 is a schematic representation of a design method according to the state of the art.

FIG. 1 shows an example of a two-dimensional vector space ( [symbol] D=2), which is spanned by a first dimension x1 and a second dimension x₂. The range of values of output variables in the two dimensions is normalized to the interval [0,1]. The dimensions are each provided with three equidistant support points (n=3) at values 0, 0.5 and 1.

In this manner, a block-by-block constant vertex matrix X_{N} results, with the nine vector space grid vectors X_{N1} . . . X_{N9}:

$${X}_{N} = ( \begin{matrix}{X}_{N 1 , 1} & {X}_{N 1 , 2} \\ {X}_{N 2 , 1} & {X}_{N 2 , 2} \\ {X}_{N 3 , 1} & {X}_{N 3 , 2} \\ {X}_{N 4 , 1} & {X}_{N 4 , 2} \\ {X}_{N 5 , 1} & {X}_{N 5 , 2} \\ {X}_{N 6 , 1} & {X}_{N 6 , 2} \\ {X}_{N 7 , 1} & {X}_{N 7 , 2} \\ {X}_{N 8 , 1} & {X}_{N 8 , 2} \\ {X}_{N 9 , 1} & {X}_{N 9 , 2}\end{matrix} ) = ( \begin{matrix}0 & 0 \\ 0.5 & 0 \\ 1 & 0 \\ 0 & 0.5 \\ 0.5 & 0.5 \\ 1 & 0.5 \\ 0 & 1 \\ 0.5 & 1 \\ 1 & 1\end{matrix} ) . \qquad ( {12}^{′} )$$

Each support point has thus assigned to it a vector space grid vector X_{Nj} with two components X_{Nj,i}:

$${X}_{Nj} = {( \begin{matrix}{X}_{Nj , 1} \\ {X}_{Nj , 2}\end{matrix} )}^{T} . \qquad ( 14 )$$

Accordingly, a vector x in the vector space generally has the form of equation (13).

In order to correctly reproduce monotonic properties when creating a conventional internal combustion engine model on vector space, it is necessary to create a finer grid spanned over the entire vector space with constraints for the gradients of the model, wherein the grid is tightly meshed in the sense that it contains more grid points GN than the internal combustion engine model has support points in the respective dimension. In particular, grid points GN are needed that are located between imaginary straight lines connecting the support points in each dimension—indicated here by a dashed circle around each of these grid points GN. This requires a considerable computational effort, which is not feasible, especially with standard PCs.

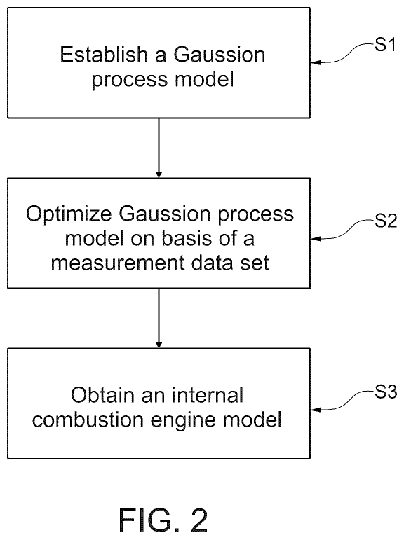

FIG. 2 shows a first schematic representation of a design example of a design method.

Identical and functionally equivalent elements are marked with the same reference symbols in all figures, so that reference is always made to the preceding description. Also, for the sake of clarity, elements that appear multiple times in a figure are marked with a corresponding reference symbol only once.

In the design method
an internal combustion engine model is created as a Gaussian process in that
as an output variable vector of the Gaussian process, a vector is used that is an element of a vector space with D>1 dimensions, wherein
in the Gaussian process, a covariance function is used, which can be represented as the product of a component-by-component calculated basis covariance function over—in particular, all—components of the output variable vector, wherein
the basis covariance function cannot be decomposed into a product of functions of exactly one dimension of the vector space over the—in particular, all—dimensions of the vector space, wherein
the Gaussian process is optimized on the basis of a measurement data set, wherein
the combustion engine model will be obtained, and
the internal combustion engine is set up to be operated with the internal combustion engine model.

The function according to equation (1) is optionally used as the basis covariance function. Similarly, the covariance function according to equation (2) is optionally used as the covariance function.

In particular, in first step S1, a Gaussian process model for the Gaussian process is established. In second step S2, the Gaussian process model is optimized on the basis of a measurement data set—optionally according to equation (4). In third step S3, the internal combustion engine model is obtained.

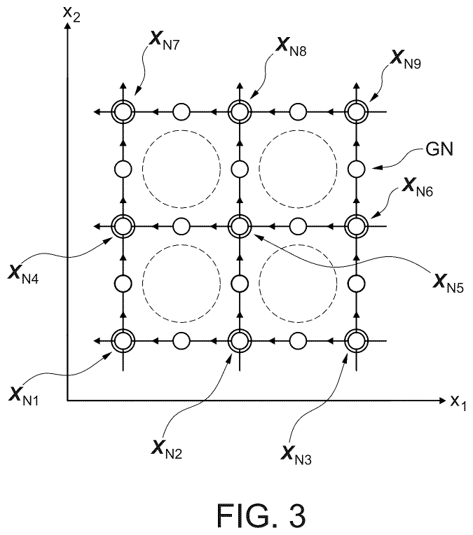

FIG. 3 shows a second schematic representation of the design method according to FIG. 2.

FIG. 3 schematically illustrates that when using the internal combustion engine model obtained according to the design method in FIG. 2, fewer grid points are advantageously required for the now coarser grid, with constraints for the gradients to ensure the monotonic properties. In particular, there is no longer a need for grid points GN that are located between the imaginary straight connecting lines of the support points in the individual dimensions, which is clearly evident from the gaps in the grid compared to the representation in FIG. 1. Specifically, no grid points GN are arranged in the dashed circles placed analogously to FIG. 1. Thus, the computational effort is significantly reduced and can even be performed on a standard PC.

The internal combustion engine model is optionally used to operate an internal combustion engine, especially to control or regulate. For this purpose, at least one input variable is added to the combustion engine model, the output variable vector is calculated using the combustion engine model, and the combustion engine is operated with the output variable vector.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating an internal combustion engine, the method comprising the steps of:
feeding at least one input variable to an internal combustion engine model;
using a Gaussian process as the internal combustion engine model;
using, as an output variable vector, a vector that is an element of a vector space with D>1 dimensions;
using a covariance function, which is configured to be represented as a product of a component-by-component calculated basis covariance function over a plurality of components of the output variable vector, wherein the basis covariance function cannot be decomposed into a product of functions of exactly one dimension of the vector space over the dimensions of the vector space;
calculating the output variable vector using the internal combustion engine model; and
operating the internal combustion engine with the output variable vector.

2. The method according to claim 1, wherein a truncated power function is used as the basis covariance function.

3. The method according to claim 2, wherein the truncated power function depends on a distance between a respective one of the plurality of components of the output variable vector and an assigned component of a predetermined vector space grid vector.

4. The method according to claim 3, wherein, as the basis covariance function, function
$${k}^{′} ( {x}_{i} , {X}_{j , i} ) = max ( 0 , {( 1 - \frac{{‖ {x}_{i} - {X}_{j , i} ‖}_{2}^{2}}{2 {l}_{N}^{2} p} )}^{p} )$$
with an output variable vector x, a vector space grid vector Xj, a length scale parameter I_{N}, and a parameter p, is used.

5. The method according to claim 1, wherein the method will be performed continuously during an operation of the internal combustion engine.

6. A method for operating an internal combustion engine, the method comprising the steps of:
operating the internal combustion engine with an internal combustion engine model;
creating the internal combustion engine model as a Gaussian process in that:
as an output variable vector of the Gaussian process, a vector is used that is an element of a vector space with D>1 dimensions;
in the Gaussian process, a covariance function is used, which is configured to be represented as a product of a component-by-component calculated basis covariance function over a plurality of components of the output variable vector, wherein the basis covariance function cannot be decomposed into a product of functions of exactly one dimension of the vector space over the dimensions of the vector space;
the Gaussian process is optimized based on a measurement data set; and
the internal combustion engine model is obtained.

7. The method according to claim 6, wherein a plurality of constraints for a plurality of gradients in the dimensions of the vector space are considered when optimizing the Gaussian process based on the measurement data set.

8. An internal combustion engine, comprising:
a control device configured to carry out a method for operating the internal combustion engine, the method including the steps of:
feeding at least one input variable to an internal combustion engine model;
using a Gaussian process as the internal combustion engine model;
using, as an output variable vector, a vector that is an element of a vector space with D>1 dimensions;
using a covariance function, which is configured to be represented as a product of a component-by-component calculated basis covariance function over a plurality of components of the output variable vector, wherein the basis covariance function cannot be decomposed into a product of functions of exactly one dimension of the vector space over the dimensions of the vector space;
calculating the output variable vector using the internal combustion engine model; and
operating the internal combustion engine with the output variable vector.
